(19) United States
(12) Patent Application Publication
(10) Pub. No.: US 2006/0226788 A1
(43) Pub. Date: Oct. 12, 2006

(54) Active matrix type display device and driving method thereof

(75) Inventor: Takashi Ogawa, Gifu (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/372,463

(22) Filed: Mar. 10, 2006

(30) Foreign Application Priority Data
Mar. 11, 2005 (JP) 2005-068812
Apr. 28, 2005 (JP) 2005-131264

(51) Int. Cl. G09G 3/10

(52) U.S. Cl. 315/169.3

(57) ABSTRACT

A residual image effect is suppressed to improve quality of display of an active matrix type display device. A capacitor line electric potential switching circuit switches an electric potential of a capacitor line from a first capacitor electric potential Vsc1 to a second capacitor electric potential Vsc2 that is higher that the first capacitor electric potential Vsc1, while a power supply electric potential switching circuit switches an electric potential of a power supply line from a first power supply electric potential PVdd1 to a second power supply electric potential PVdd2 that is lower than the first power supply electric potential PVdd1. As a result of synergistic effect, an electric potential Vg at a gate of a driver TFT becomes higher than an electric potential at its source by more than a threshold voltage Vtp of the driver TFT. Assuming carriers are trapped in a gate insulation film of the driver TFT due to writing-in of a display signal in a preceding frame period, the carriers are extracted from the gate insulation film to the source or a drain of the driver TFT. With this, electric characteristics of the driver TFT are initialized.

### CROSS-REFERENCE OF THE INVENTION

This invention is based on Japanese Patent Applications No. 2005-068812 and No. 2005-131264, the content of which is incorporated herein by reference in its entirety.

### BACKGROUND OF THE INVENTION

1. Field of the Invention

This invention relates to an active matrix type display device and a driving method thereof.

2. Description of the Related Art

Organic EL display devices using organic electro luminescent devices (hereafter referred to as organic EL devices) have been developed in recent years as display devices to replace CRT and LCD. An emphasis is laid on development of an active matrix type organic EL display device that uses a thin film transistor (hereafter referred to as TFT) as a switching device to drive the organic EL device.

The active matrix type organic EL display device will be explained hereinafter, referring to the drawing. FIG. 11 is an equivalent circuit diagram of the organic EL display device. Only one display pixel 210 is shown in FIG. 11 out of a plurality of display pixels arrayed in a matrix form in a display panel of the organic EL display device.

An N-channel type pixel selection TFT 213 is disposed around an intersection of a pixel selection signal line 211 extending in a row direction and a display signal line 212 extending in a column direction. A gate of the pixel selection TFT 213 is connected to the pixel selection signal line 211, while a drain of the pixel selection TFT 213 is connected to the display signal line 212. The pixel selection TFT 213 is turned on according to a high level of a pixel selection signal G, which is outputted from a vertical drive circuit 301 and applied to the pixel selection signal line 211. A display signal D is outputted from a horizontal drive circuit 302 to the display signal line 212.

A source of the pixel selection TFT 213 is connected to a gate of a P-channel type driver TFT 214. A source of the driver TFT 214 is connected to a power supply line 215 that supplies a positive power supply electric potential PVdd. A drain of the driver TFT 214 is connected to an anode of an organic EL device 216. A negative power supply electric potential CV is supplied to a cathode of the organic EL device 216.

A storage capacitor 218 is connected between the gate of the driver TFT 214 and a capacitor line 217. The capacitor line 217 is connected to a fixed electric potential. The storage capacitor 218 retains the display signal D applied to the gate of the driver TFT 214 through the pixel selection TFT 213 for one horizontal period.

Next, operation of the organic EL display device described above will be explained. The pixel selection TFT 213 is turned on when the high level of the pixel selection signal G, that lasts for one horizontal period, is applied to the pixel selection line 211. Then the display signal D outputted to the display signal line 212 is applied to the gate of the driver TFT 214 through the pixel selection TFT 213 and retained by the storage capacitor 218. In other words, the display signal D is written into the display pixel 210.

A conductance of the driver TFT 214 varies according to the display signal D applied to the gate of the driver TFT 214. When the driver TFT 214 is turned on, it provides the organic EL device 216 with an electric current corresponding to the conductance and the organic EL device 216 is driven to a brightness level corresponding to the electric current. On the other hand, when the driver TFT 214 is turned off accordingly to the display signal D supplied to its gate, the organic EL device 216 is extinguished because no electric current flows through the driver TFT 214.

A desired image can be displayed on the entire display panel by performing the operation described above for all the rows of the display pixels 210 over one frame period.

Further description on the technologies mentioned above is provided in Japanese Patent Application Publication No. 2004-341435.

With the organic EL display device described above, however, there is a problem of deterioration in quality of display, which is caused on a part of the display panel by a residual image due to light emission of the organic EL device 216. This is because an electric current of a current value different from a current value expected according to the display signal D, that is written into the driver TFT 214 in a certain display pixel in a current frame period, flows through the driver TFT 214, depending on a conduction state (ON state or OFF state) of the driver TFT 214 into which the display signal D in a preceding frame period has been written. In other words, the electric current that flows through the driver TFT 214 exhibits hysteresis. The hysteresis is particularly apparent when the display signal D is at an intermediate level between a high level and a low level.

According to a study conducted by the inventors, the hysteresis is considered to be due to a change in a threshold voltage of the driver TFT 214 caused by carriers trapped in a gate insulation film of the driver TFT 214 when the display signal D is written-in during the preceding frame period.

### SUMMARY OF THE INVENTION

This invention offers an active matrix type display device with improved quality of display by suppressing the residual image on the display panel as described above.

The invention provides an active matrix type display device that includes a plurality of display pixels arrayed in a matrix form, each of the display pixels including a pixel selection transistor that is turned on according to a pixel selection signal, a light-emitting device, a driver transistor that is connected to a power supply line and drives the light-emitting device according to a display signal applied through the pixel selection transistor and a storage capacitor that is connected between a gate of the driver transistor and a capacitor line and retains the display signal, and a capacitor line electric potential switching circuit that switches an electric potential of the capacitor line from a first capacitor electric potential to a second capacitor electric potential that is different from the first capacitor electric potential to turn the driver transistor off and switches the electric potential of the capacitor line back to the first capacitor electric potential from the second capacitor electric potential.

The invention also provides an active matrix type display device that includes, in addition to the structure described above, a power supply electric potential switching circuit that switches an electric potential of the power supply line from a first power supply electric potential to a second power supply electric potential that is different from the first power supply electric potential and switches the electric potential of the power supply line back to the first power supply electric potential from the second power supply electric potential.

The invention also provides an active matrix type display device that includes a plurality of display pixels arrayed in a matrix form, each of the display pixels including a pixel selection transistor that is turned on according to a pixel selection signal, a light-emitting device, a driver transistor that is connected to a power supply line and drives the light-emitting device according to a display signal applied through the pixel selection transistor and a storage capacitor that is connected between a gate of the driver transistor and a capacitor line and retains the display signal, and a power supply electric potential switching circuit that switches an electric potential of the power supply line from a first power supply electric potential to a second power supply electric potential that is different from the first power supply electric potential to turn the driver transistor off and switches the electric potential of the power supply line back to the first power supply electric potential from the second power supply electric potential.

The invention further provides an active matrix type display device that includes a plurality of display pixels arrayed in a matrix form, each of the display pixels including a pixel selection transistor that is turned on according to a pixel selection signal, a light-emitting device that has an anode and a cathode, a driver transistor that is connected to a power supply line and the anode of the light-emitting device and drives the light-emitting device according to a display signal applied through the pixel selection transistor and a storage capacitor that is connected between a gate of the driver transistor and a capacitor line and retains the display signal, a capacitor line electric potential switching circuit that switches an electric potential of the capacitor line from a first capacitor electric potential to a second capacitor electric potential that is higher than the first capacitor electric potential to turn off the driver transistor and the light-emitting device and switches the electric potential of the capacitor line back to the first capacitor electric potential from the second capacitor electric potential, and a power supply electric potential switching circuit that reduces an electric potential of the power supply line and an electric potential at the cathode of the light-emitting device for a predetermined period so that a difference between an electric potential at a gate and an electric potential at a source of the driver transistor and a difference between an electric potential at a drain and the electric potential at the source of the driver transistor become larger than those in a non-light-emitting period of the light-emitting device.

The invention provides a method of driving an active matrix type display device that has a plurality of display pixels arrayed in a matrix form, each of the display pixels having a pixel selection transistor that is turned on according to a pixel selection signal, a light-emitting device, a driver transistor that is connected to a power supply line and drives the light-emitting device according to a display signal applied through the pixel selection transistor and a storage capacitor that is connected between a gate of the driver transistor and a capacitor line and retains the display signal, the method including switching an electric potential of the capacitor line from a first capacitor electric potential to a second capacitor electric potential to turn the driver transistor off, switching the electric potential of the capacitor line back to the first capacitor electric potential from the second capacitor electric potential and after that applying the display signal to the driver transistor through the pixel selection transistor according to the pixel selection signal.

The invention also provides a method of driving an active matrix type display device, which includes, in addition to the method described above, switching an electric potential of the power supply line from a first power supply electric potential to a second power supply electric potential that is different from the first power supply electric potential and switching the electric potential of the power supply line back to the first power supply electric potential from the second power supply electric potential.

The invention also provides a method of driving an active matrix type display device that has a plurality of display pixels arrayed in a matrix form, each of the display pixels having a pixel selection transistor that is turned on according to a pixel selection signal, a light-emitting device, a driver transistor that is connected to a power supply line and drives the light-emitting device according to a display signal applied through the pixel selection transistor and a storage capacitor that is connected between a gate of the driver transistor and a capacitor line and retains the display signal, the method including switching an electric potential of the power supply line from a first power supply electric potential to a second power supply electric potential to turn the driver transistor off, switching the electric potential of the power supply line back to the first power supply electric potential from the second power supply electric potential and after that applying the display signal to the driver transistor through the pixel selection transistor according to the pixel selection signal.

The invention further provides a method of driving an active matrix type display device that has a plurality of display pixels arrayed in a matrix form, each of the display pixels having a pixel selection transistor that is turned on according to a pixel selection signal, a light-emitting device that has an anode and a cathode, a driver transistor that is connected to a power supply line and the anode of the light-emitting device and drives the light-emitting device according to a display signal applied through the pixel selection transistor and a storage capacitor that is connected between a gate of the driver transistor and a capacitor line and retains the display signal, the method includes reducing an electric potential of the power supply line and an electric potential at the cathode of the light-emitting device for a predetermined period so that a difference between an electric potential at a gate and an electric potential at a source of the driver transistor and a difference between an electric potential at a drain and the electric potential at the source of the driver transistor become larger than those in a non-light-emitting period of the light-emitting device and applying the display signal of a predetermined electric potential and the pixel selection signal of another predetermined electric potential that is higher than the predetermined electric potential of the display signal for the predetermined period.

### BRIEF DESCRIPTION OF THE DRAWINGS

FIG. 1 is an equivalent circuit diagram of an organic EL display device according to a first embodiment of this invention.

FIG. 2 is a timing chart showing a method to drive the organic EL display device according to the first embodiment of this invention.

FIG. 3 shows a correlation between duration of a residual image of an organic EL device and a blanking ratio.

FIG. 4 is an equivalent circuit diagram of an organic EL display device according to a second embodiment of this invention.

FIG. 5 is a timing chart showing a method to drive the organic EL display device according to the second embodiment of this invention.

FIG. 6 is an equivalent circuit diagram of an organic EL display device according to a third embodiment of this invention.

FIGS. 7A, 7B and 7C are timing charts showing a method to drive the organic EL display device according to the third embodiment of this invention.

FIG. 8 is an equivalent circuit diagram of an organic EL display device according to a fourth embodiment of this invention.

FIGS. 9A and 9B show correlations between a leakage current and an electric potential at a gate of a driver transistor.

FIG. 10 is an equivalent circuit diagram of an organic EL display device according to a fifth embodiment of this invention.

FIG. 11 is an equivalent circuit diagram showing an organic EL display device according to a prior art.

### DETAILED DESCRIPTION OF THE INVENTION

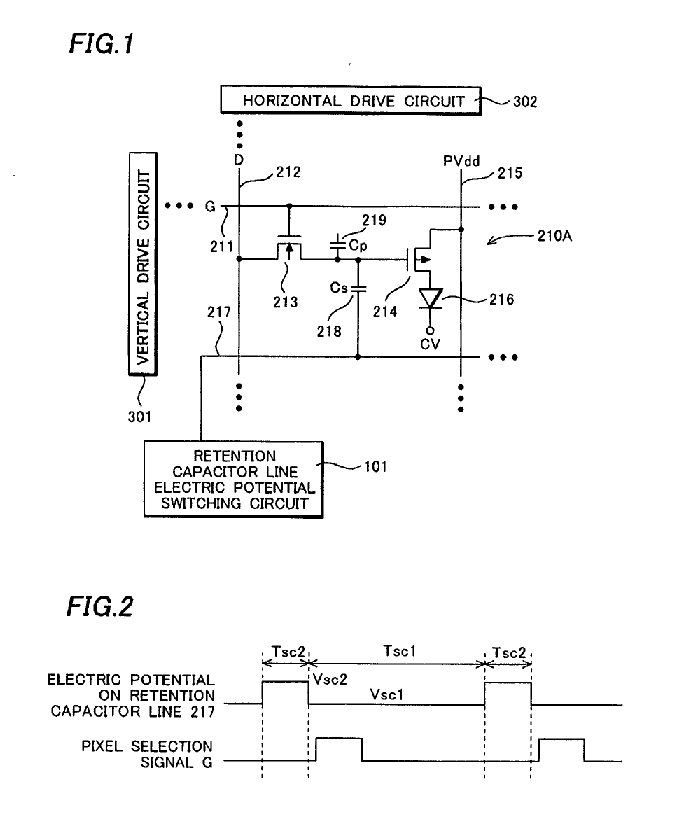

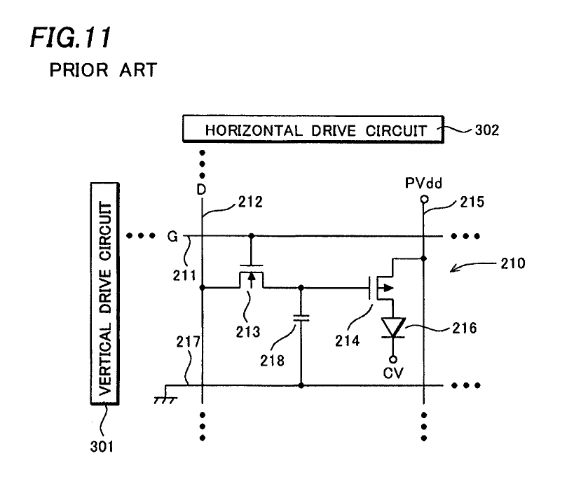

An active matrix type organic EL display device and a driving method thereof according to a first embodiment of this invention will be described hereafter referring to the drawings. FIG. 1 is an equivalent circuit diagram showing the organic EL display device according to the embodiment. Only one display pixel 210A is shown in FIG. 1 out of a plurality of display pixels arrayed in a matrix form in a display panel of the organic EL display device. The same components in FIG. 1 as in FIG. 11 are denoted by the same symbols, and the explanations thereof are omitted.

The organic EL display device has a capacitor line electric potential switching circuit 101 that is connected to a capacitor line 217 in the display pixel 210A, as shown in FIG. 1. The capacitor line electric potential switching circuit 101 switches an electric potential of the capacitor line 217 from a first capacitor electric potential Vsc1 to a second capacitor electric potential Vsc2 that is higher than the first capacitor electric potential Vsc1 to turn a driver TFT 214 off and switches the electric potential of the capacitor line 217 back to the first capacitor electric potential Vsc1 from the second capacitor electric potential Vsc2.

It is preferable that the organic EL display device of this embodiment meets specifications shown in Table 1.

TABLE 1
Specifications of Organic EL Display Device
according to First Embodiment

| | | |
|---|---|---|
| Vsc1: First Capacitor Electric Potential | −10-2 | V |
| Vsc2: Second Capacitor Electric Potential | 2-15 | V |
| PVdd: Positive Power Supply Electric | 0-12 | V |
| Potential | | |
| CV: Negative Power Supply Electric | −12-0 | V |
| Potential | | |
| Vsig: Electric Potential of Display | 0-10 | V |
| Signal D | | |
| W: Channel Width | 3-100 | μm |
| L: Channel Length | 3-100 | μm |
| μ: Mobility of Carriers | 10-300 | cm²/VS |
| Cox: Gate Capacitance | 1 × 10⁻⁴-1 × 10⁻³ | F/m² |
| Tsc2/(Tsc1 + Tsc2) | 1/300 or above | |

Table 1 shows allowable ranges of a positive power supply electric potential PVdd, a negative power supply electric potential CV, an electric potential Vsig of a display signal D, the first capacitor electric potential Vsc1 and the second capacitor electric potential Vsc2. A channel width W, a channel length L, carrier mobility μ and a gate capacitance Cox in Table 1 are parameters specifying the driver TFT 214.

And Tsc1 denotes a period during which the electric potential of the capacitor line 217 is at the first capacitor electric potential Vsc1, while Tsc2 denotes a period during which the electric potential of the capacitor line 217 is at the second capacitor electric potential Vsc2. Here, in the period Tsc2 during which the electric potential of the capacitor line 217 is at the second capacitor electric potential Vsc2, it is required that the electric potentials and the parameters in Table 1 are set so that an electric potential Vg at a gate of the driver TFT 214 and a threshold voltage Vtp of the driver TFT 214 satisfy Equation 1:
Vg−PVdd>Vtp Equation 1:

Next, a driving method of the organic EL display device described above will be explained referring to the drawings. FIG. 2 is a timing chart to explain the driving method of the organic EL display device according to the embodiment.

The capacitor line electric potential switching circuit 101 initially outputs the first capacitor electric potential Vsc1 and switches from the first capacitor electric potential Vsc1 to the second capacitor electric potential Vsc2 at a predetermined timing to raise the electric potential of the capacitor line 217 to the second capacitor electric potential Vsc2, as shown in FIG. 2.

Then the electric potential Vg at the gate of the driver TFT 214 is raised by capacitive coupling through the storage capacitor 218, in response to a voltage change ΔV from the first capacitor electric potential Vsc1 to the second capacitor electric potential Vsc2. As a result, the electric potential Vg at the gate of the driver TFT 214 becomes higher than an electric potential at its source by more than a threshold voltage Vtp of the driver TFT 214, turning the driver TFT 214 into an OFF state. Following Equation 2 holds, where VsigMIN denotes a minimum value of the electric potential Vsig of the display signal D, Cs denotes a capacitance of the storage capacitor 218 and Cp denotes a capacitance of a parasitic capacitor 219 of a wiring connected to the gate of the driver TFT 214.

$$Equation 2 \text{:}$$

$$VsigMIN + \frac{Cs \cdot Δ V}{Cs \cdot Cp} - PVdd ≻ Vtp$$

At that time, assuming that carriers have been trapped in a gate insulation film of the driver TFT 214 by writing-in of the display signal D during a preceding frame period, the carriers are extracted from the gate insulation film to the source or a drain of the driver TFT 214 by an electric field from the gate to the source or the drain. With this, electric characteristics of the driver TFT 214 are initialized. That is, a residual image is suppressed while an organic EL device 216 does not emit light.

Next, after the electric characteristics of the driver TFT 214 are initialized, the capacitor line electric potential switching circuit 101 switches the electric potential of the capacitor line 217 back to the first capacitor electric potential Vsc1 from the second capacitor electric potential Vsc2. As a result, the electric potential Vg at the gate of the driver TFT 214 returns to the initial state and the storage capacitor 218 resumes the status in which the original display signal D is retained.

In order to initialize the electric characteristics of the driver TFT 214, the period Tsc2 during which the electric potential of the capacitor line 217 is at the second capacitor electric potential Vsc2 is to be equal to or longer than one 300th of a sum of the period Tsc2 and the period Tsc1 during which the electric potential of the capacitor line 217 is at the first capacitor electric potential Vsc1, as shown in Table 1. With the organic EL display device shown in Table 1, assuming one frame period is 16.6 ms, for example, a period during which the driver TFT 214 is turned off and thus the organic EL device 216 does not emit light is to be 0.055 ms or longer.

After that, a high level of a pixel selection signal G is outputted from a vertical drive circuit 301, and accordingly a pixel selection TFT 213 is turned on for one horizontal period. During the one horizontal period, the display signal D is outputted from a horizontal drive circuit 302 to a display signal line 212 in the display pixel 210A, and the display signal D is applied to the gate of the driver TFT 214 through the pixel selection TFT 213 and retained in the storage capacitor 218. An electric current corresponding to the display signal D is supplied from the driver TFT 214 to an organic EL device 216 and drives the organic EL device 216 to emit light.

According to the embodiment, as described above, the residual image on the display panel can be suppressed to improve the quality of the display, since the carriers in the gate insulation film of the driver TFT 214 are extracted to initialize the electric characteristics of the driver TFT 214 before the organic EL device 216 emits light corresponding to the display signal D.

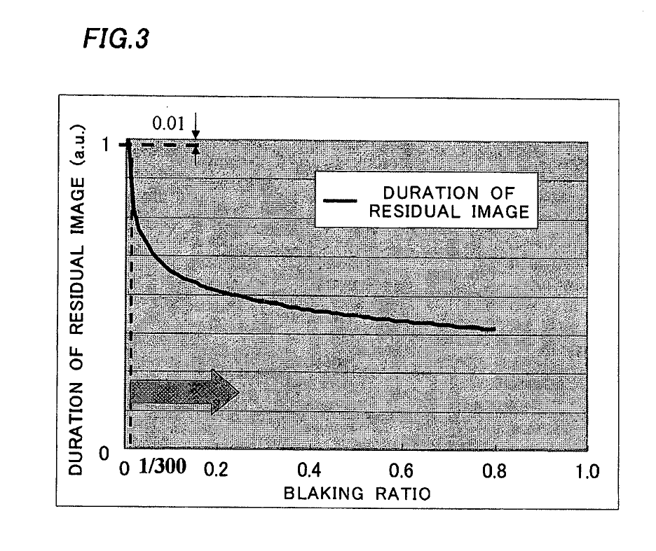

The period Tsc2 during which the electric potential of the capacitor line 217 is at the second capacitor electric potential Vsc2 is made to be equal to or longer than one 300th of the sum of the period Tsc2 and the period Tsc1 during which the electric potential of the capacitor line 217 is at the first capacitor electric potential Vsc1 in this embodiment. This is derived from a correlation between duration of residual image and a blanking ratio (a ratio of a non-light-emitting period to a sum of a light-emitting period and the non-light-emitting period of the organic EL device 216), which is shown in FIG. 3.

In FIG. 3, the duration of residual image (in arbitrary unit) is assumed to be one when the blanking ratio is zero (i.e. when the organic EL device 216 continues to emit light). An experiment conducted by the inventors showed that the residual image of the organic EL device 216 was recognizable when the duration of residual image was reduced by 0.01 or above of the duration of residual image for the blanking ratio of zero.

That is, the duration of residual image is reduced by 0.01 or more in a range where the blanking ratio is one 300th or above compared with the case where the duration of residual image is one (when the blanking ratio is zero). Thus, it is understood that an effect of suppression of the residual image is obtained in that range.

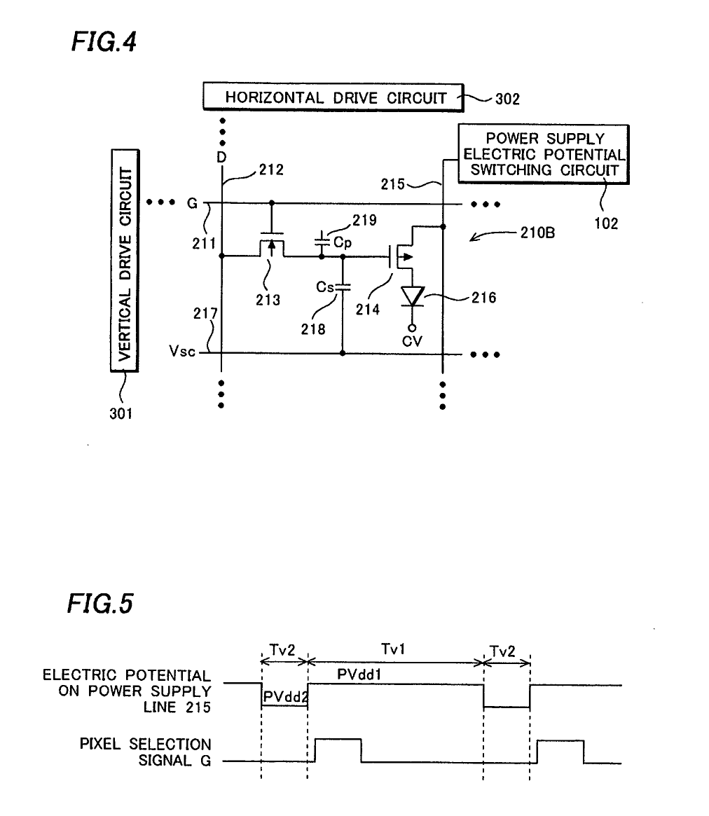

Next, an active matrix type organic EL display device and a driving method thereof according to a second embodiment of this invention will be described hereafter referring to the drawings. FIG. 4 is an equivalent circuit diagram showing the organic EL display device according to the second embodiment. Only one display pixel 210B is shown in FIG. 4 out of a plurality of display pixels arrayed in a matrix form in a display panel of the organic EL display device. The same components in FIG. 4 as in FIG. 1 or FIG. 11 are denoted by the same symbols, and the explanations thereof are omitted.

Unlike the first embodiment, an electric potential of a capacitor line 217 in the display pixel 210B is kept at a fixed electric potential Vsc in the organic EL display device of the second embodiment, as shown in FIG. 4. Also, the organic EL display device has a power supply electric potential switching circuit 102 that is connected to a power supply line 215. The power supply electric potential switching circuit 102 switches an electric potential of the power supply line 215 from a first power supply electric potential PVdd1 to a second power supply electric potential PVdd2 that is lower than the first power supply electric potential PVdd1 to turn a driver TFT 214 off, and switches the electric potential of the power supply line 215 back to the first power supply electric potential PVdd1 from the second power supply electric potential PVdd2.

It is preferable that the organic EL display device of this embodiment meets specifications shown in Table 2.

TABLE 2
Specifications of Organic EL Display Device according
to Second Embodiment

| | | |
|---|---|---|
| Vsc: Electric Potential of Capacitor Line | −10-15 | V |
| 217 | | |
| PVdd1: First Power Supply Electric | 2-15 | V |
| Potential | | |
| PVdd2: Second Power Supply Electric | −10-2 | V |
| Potential | | |
| CV: Negative Power Supply Electric | −12-0 | V |
| Potential | | |
| Vsig: Electric Potential of Display | 0-10 | V |
| Signal D | | |
| W: Channel Width | 3-100 | μm |
| L: Channel Length | 3-100 | μm |
| μ: Mobility of Carriers | 10-300 | cm²/VS |
| Cox: Gate Capacitance | 1 × 10⁻⁴-1 × 10⁻³ | F/m² |
| Tv2/(Tv1 + Tv2) | 1/300 or above | |

Each of items in Table 2 having notations common to items in Table 1 denotes each of the corresponding items in Table 1 such as electric potentials and parameters.

And Tv1 denotes a period during which the electric potential of the power supply line 215 is at the first power supply electric potential PVdd1, while Tv2 denotes a period during which the electric potential of the power supply line 215 is at the second power supply electric potential PVdd2. Here, it is required that the electric potentials and the parameters in Table 2 are set so that an electric potential Vg at a gate of the driver TFT 214 and a threshold voltage Vtp of the driver TFT 214 satisfy following Equation 3.
Vg−PVdd2>Vtp Equation 3:

Next, a driving method of the organic EL display device described above will be explained referring to the drawings. FIG. 5 is a timing chart to explain the driving method of the organic EL display device according to the second embodiment.

The power supply electric potential switching circuit 102 initially outputs the first power supply electric potential PVdd1 and switches from the first power supply electric potential PVdd1 to the second power supply electric potential PVdd2 at a predetermined timing to reduce the electric potential of the power supply line 215 to the second power supply electric potential PVdd2, as shown in FIG. 5.

As a result, the electric potential Vg at the gate of the driver TFT 214 becomes higher than the electric potential PVdd2 at its source by more than a threshold voltage Vtp of the driver TFT 214, turning the driver TFT 214 into an OFF state. That is, following Equation 4 holds:
Vg−PVdd2>Vtp Equation 4:

At that time, assuming that carriers have been trapped in a gate insulation film of the driver TFT 214 by writing-in of the display signal D during a preceding frame period, the carriers are extracted from the gate insulation film to the source or a drain of the driver TFT 214 by an electric field from the gate to the source or the drain. With this, electric characteristics of the driver TFT 214 are initialized.

Next, after the electric characteristics of the driver TFT 214 are initialized, the power supply electric potential switching circuit 102 switches the electric potential of the power supply line 215 back to the first power supply electric potential PVdd1 from the second power supply electric potential PVdd2. An electric current corresponding to the display signal D is supplied from the driver TFT 214 to an organic EL device 216 and drives the organic EL device 216 to emit light, as in the first embodiment.

In order to initialize the electric characteristics of the driver TFT 214, the period Tv2 during which the electric potential of the power supply line 215 is at the second power supply electric potential PVdd2 is to be equal to or longer than one 300th of a sum of the period Tv2 and the period Tv1 during which the electric potential of the power supply line 215 is at the first power supply electric potential PVdd1 (based on FIG. 3 as in the first embodiment), as shown in Table 2. With the organic EL display device shown in table 2, assuming one frame period is 16.6 ms, for example, a period during which the driver TFT 214 is turned off and thus the organic EL device 216 does not emit light is to be 0.055 ms or longer.

According to the second embodiment, as in the first embodiment, the residual image on the display panel can be suppressed to improve the quality of the display, since the carriers in the gate insulation film of the driver TFT 214 are extracted to initialize the electric characteristics of the driver TFT 214 before the organic EL device 216 emits light corresponding to the display signal D.

This invention can be applied to a case in which the first and second embodiments are implemented together. An active matrix type organic EL display device and a driving method thereof according to such a case, that is a third embodiment of this invention, will be described hereafter referring to the drawings.

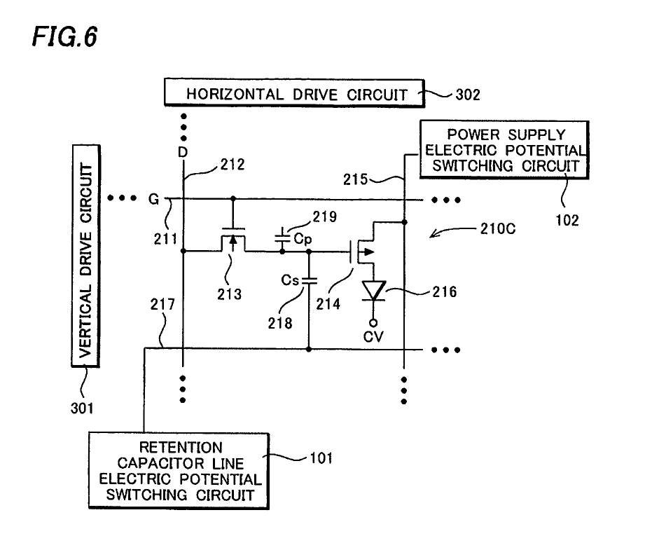

FIG. 6 is an equivalent circuit diagram showing the organic EL display device according to the third embodiment. Only one display pixel 210C is shown in FIG. 6 out of a plurality of display pixels arrayed in a matrix form in a display panel of the organic EL display device. The same components in FIG. 6 as in FIG. 1, FIG. 4 or FIG. 11 are denoted by the same symbols, and the explanations thereof are omitted.

The organic EL display device has a capacitor line electric potential switching circuit 101 that is connected to a capacitor line 217 in the display pixel 210C and a power supply electric potential switching circuit 102 that is connected to a power supply line 215, as shown in FIG. 6. The capacitor line electric potential switching circuit 101 is the same electric potential switching circuit as shown in the first embodiment, while the power supply electric potential switching circuit 102 is the same electric potential switching circuit as shown in the second embodiment.

It is preferable that the organic EL display device of this embodiment meets specifications shown in Table 3.

TABLE 3
Specifications of Organic EL Display Device
according to Third Embodiment

| | | |
|---|---|---|
| PVdd1: First Power Supply Electric | 2-15 | V |
| Potential | | |
| PVdd2: Second Power Supply Electric | −10-2 | V |
| Potential | | |
| Vsc1: First Capacitor Electric Potential | −10-2 | V |
| Vsc2: Second Capacitor Electric Potential | 2-15 | V |
| CV: Negative Power Supply Electric | −12-0 | V |
| Potential | | |
| Vsig: Electric Potential of Display | 0-10 | V |
| Signal D | | |
| W: Channel Width | 3-100 | μm |
| L: Channel Length | 3-100 | μm |
| μ: Mobility of Carriers | 10-300 | cm²/VS |
| Cox: Gate Capacitance | 1 × 10⁻⁴-1 × 10⁻³ | F/m² |
| Tsc2/(Tsc1 + Tsc2) | 1/300 or above | |

Each of items in Table 3 having notations common to items in Table 1 or Table 2 denotes each of the corresponding items in Table 1 or Table 2 such as electric potentials and parameters.

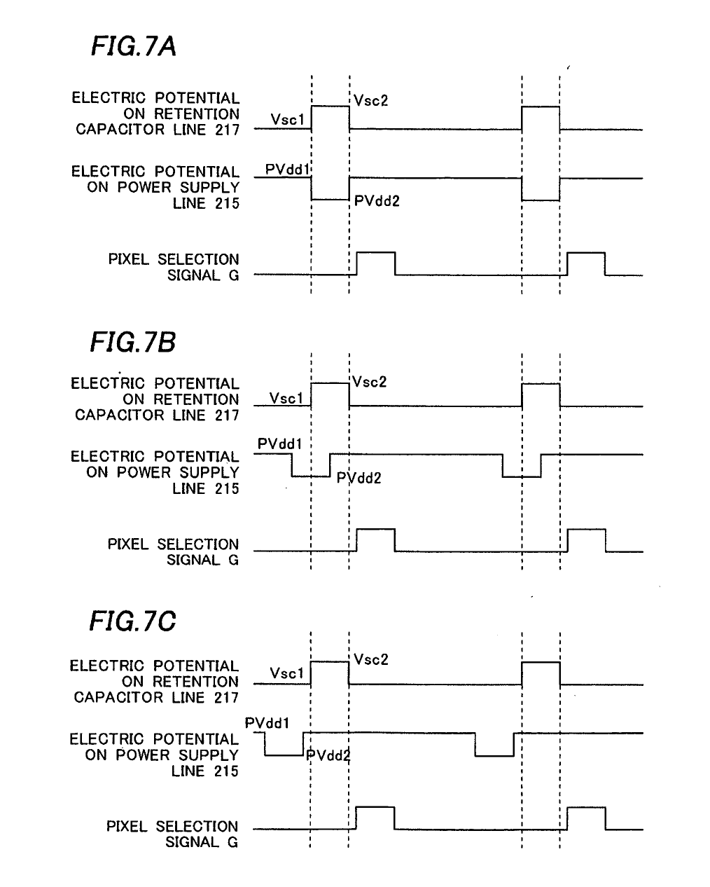

Next, a driving method of the organic EL display device described above will be explained referring to the drawings. FIG. 7 is a timing chart to explain the driving method of the organic EL display device according to the third embodiment.

The capacitor line electric potential switching circuit 101 switches an electric potential of the capacitor line 217 from a first capacitor electric potential Vsc1 to a second capacitor electric potential Vsc2 at the same time as the power supply electric potential switching circuit 102 switches an electric potential of the power supply line 215 from a first power supply electric potential PVdd1 to a second power supply electric potential PVdd2, as shown in FIG. 7A.

Then an electric potential Vg at a gate of a driver TFT 214 is raised in response to a voltage change ΔV from the first capacitor electric potential Vsc1 to the second capacitor electric potential Vsc2 while an electric potential at a source of the driver TFT 214 drops to the second power supply electric potential PVdd2 at the same time. As a result of synergistic effect, the electric potential Vg at the gate of the driver TFT 214 becomes higher than the electric potential PVdd2 at its source by more than a threshold voltage Vtp of the driver TFT 214, turning the driver TFT 214 into an OFF state. That is, following Equation 5 holds:
Vg−PVdd>Vtp Equation 5:

At that time, assuming that carriers have been trapped in a gate insulation film of the driver TFT 214 by writing-in of the display signal D during a preceding frame period, the carriers are extracted from the gate insulation film to the source or a drain of the driver TFT 214 by an electric field from the gate to the source or the drain. With this, electric characteristics of the driver TFT 214 are initialized.

Next, after the electric characteristics of the driver TFT 214 are initialized, the capacitor line electric potential switching circuit 101 switches the electric potential of the capacitor line 217 back to the first capacitor electric potential Vsc1 from the second capacitor electric potential Vsc2 while the power supply electric potential switching circuit 102 switches the electric potential of the power supply line 215 back to the first power supply electric potential PVdd1 from the second power supply electric potential PVdd2 at the same time. As a result, the electric potential Vg at the gate of the driver TFT 214 returns to the initial state and the storage capacitor 218 resumes the status in which the original display signal D is retained. An electric current corresponding to the display signal D is supplied from the driver TFT 214 to an organic EL device 216 and drives the organic EL device 216 to emit light, as in the first and second embodiments.

In order to initialize the electric characteristics of the driver TFT 214, as in the first embodiment, the period Tsc2 during which the electric potential of the capacitor line 217 is at the second capacitor electric potential Vsc2 is to be equal to or longer than one 300th of a sum of the period Tsc2 and the period Tsc1 during which the electric potential of the capacitor line 217 is at the first capacitor electric potential Vsc1 (based on FIG. 3 as in the first embodiment). With the organic EL display device shown in Table 3, assuming one frame period is 16.6 ms, for example, a period during which the driver TFT 214 is turned off and thus the organic EL device 216 does not emit light is to be 0.055 ms or longer.

A switching timing of the electric potential of the capacitor line 217 and a switching timing of the electric potential of the power supply line 215 are not necessarily required to coincide with each other. That is, the period during which the electric potential of the capacitor line 217 is at the first capacitor electric potential Vsc1 (or at the second capacitor electric potential Vsc2) may be shifted in time from the period during which the electric potential of the power supply line 215 is at the first power supply electric potential PVdd1 (or at the second power supply electric potential PVdd2) so as to partially overlap with each other, as long as the both periods have the same cycle period, as shown in FIG. 7B. Or the both periods may be shifted in time so as not to overlap with each other, as long as the both periods have the same cycle period, as shown in FIG. 7C. When a driving method as shown in FIG. 7C is implemented, however, the organic EL display device is not limited to meet the specifications shown in Table 3.

According to the third embodiment, the carriers in the gate insulation film of the driver TFT 214 are extracted by switching both the electric potentials on the capacitor line 217 and the power supply line 215 to raise the electric potential at the gate of the driver TFT 214 higher than the electric potential at its source. Because the electric potential at the gate of the driver TFT 214 is made higher than that in the first and second embodiments, the initialization of the electric characteristics of the driver TFT 214 can be made with more reliability than in the first and second embodiments.

In the first embodiment described above, a leakage current is caused between the source and the drain of the driver TFT 214 in the non-light-emitting period, that is, the period during which the electric potential of the capacitor line 217 is at the second capacitor electric potential Vsc2. The leakage current is considered to be caused because a reverse bias is applied to a PN junction between a P-type region and an N-type region constituting the driver TFT 214 by the raised electric potential Vg at the gate of the driver TFT 214 according to the voltage change ΔV from the first capacitor electric potential Vsc1 to the second capacitor electric potential Vsc2.

The leakage current that flows into the drain of the driver TFT 214, that is, the anode of the organic EL device 216 turns on the organic EL device 216 in the non-light-emitting period, during which the organic EL device 216 is supposed not to be tuned on. As a result, there is caused a display pixel that makes a bright spot on the display panel, deteriorating the quality of display.

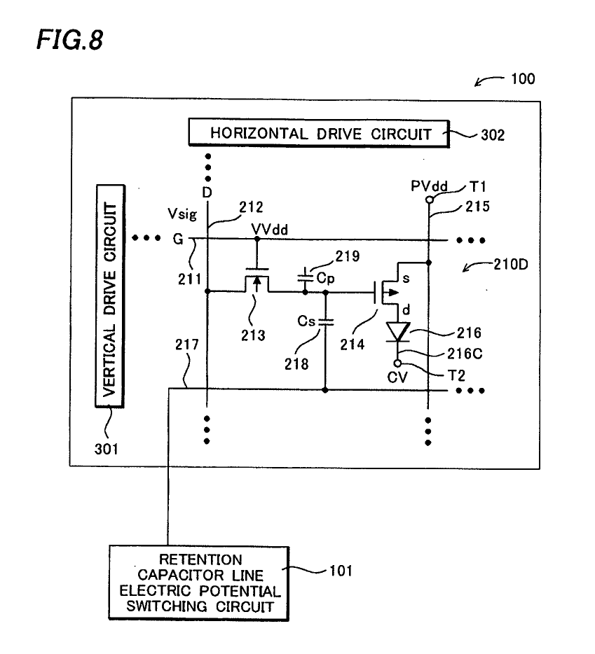

In order to cope with this problem, the inventors have devised a fourth embodiment of this invention, which is described below. An active matrix type organic EL display device and a driving method thereof according to the fourth embodiment of this invention will be described hereafter referring to the drawings. FIG. 8 is an equivalent circuit diagram showing the organic EL display device according to the fourth embodiment. Only one display pixel 210D is shown in FIG. 8 out of a plurality of display pixels arrayed in a matrix form in a display panel 100 of the organic EL display device. The same components and signals in FIG. 8 as in FIG. 1, FIG. 4, FIG. 7 or FIG. 11 are denoted by the same symbols, and the explanations thereof are omitted.

The organic EL display device has a capacitor line electric potential switching circuit 101 that is connected to a capacitor line 217 in the display pixel 210D, as shown in FIG. 8. The capacitor line electric potential switching circuit 101 switches an electric potential of the capacitor line 217 from a first capacitor electric potential Vsc1 to a second capacitor electric potential Vsc2 that is higher than the first capacitor electric potential Vsc1 to turn a driver TFT 214 off and switches the electric potential of the capacitor line 217 back to the first capacitor electric potential Vsc1 from the second capacitor electric potential Vsc2.

A power supply line 215 has a terminal T1 to which an external voltage is applied, while a cathode 216C of an organic EL device 216 has a terminal T2 to which an external voltage is applied.

Next, a driving method of the organic EL display device according to the fourth embodiment will be explained. The driving method of the organic EL device in normal usage is the same as the driving method of the organic EL display device of the first embodiment shown in FIG. 2. Following voltage application processing is conducted on the organic EL display device in the fourth embodiment, before the organic EL display device is shipped to a user. The user drives the organic EL display device on which the voltage application processing has been conducted.

In the voltage application processing, an electric potential PVdd on the power supply line 215 and an electric potential CV at the cathode 216C are reduced for a predetermined period so that an electric potential difference Vgs between a gate and a source of the driver TFT 214 and an electric potential difference Vds between a drain and the source of the driver TFT 214 are larger than those in a non-light-emitting period of the organic EL device 216. Also, at the same time, a display signal D of a predetermined electric potential and a pixel selection signal G of another predetermined electric potential that is higher than the predetermined electric potential of the display signal D are applied to the display pixel 210D for the predetermined period.

When the electric potential PVdd on the power supply line 215 and the electric potential CV at the cathode 216C are reduced, the external voltages are applied to the terminal T1 and the terminal T2. When the display signal D and the pixel selection signal G of the predetermined electric potentials are applied, voltages provided from a vertical drive circuit 301 and a horizontal drive circuit 302 are used.

Here, the electric potential difference Vgs between the gate and the source of the driver TFT 214 and the electric potential difference Vds between the drain and the source of the driver TFT 214 need to be equal to or larger than 10V, and are preferably equal to or larger than 15V. In order to make the electric potential differences available, it is preferable that the electric potential PVdd on the power supply line 215 is approximately −5V, the electric potential CV at the cathode 216C is approximately −20V, the predetermined electric potential of the display signal D is approximately 10V and the another predetermined electric potential of the pixel selection signal G is approximately 12V. Or the electric potentials mentioned above may be of values other than described above, as long as they make the electric potential difference Vgs between the gate and the source and the electric potential difference Vds between the drain and the source of the driver TFT 214 larger than those in the non-light-emitting period of the organic EL device 216. A period of the voltage application processing (a period during which the electric potentials described above are maintained) is in a range between approximately 1 μsec and approximately 10 sec, for example, although it is not particularly limited to the above.

An experiment conducted by the inventors has made it clear that the leakage current to the drain of the driver TFT 214 is reduced by the voltage application processing described above compared to the case where no voltage application processing is performed. Next, the reduction in the leakage current will be explained referring to the drawings.

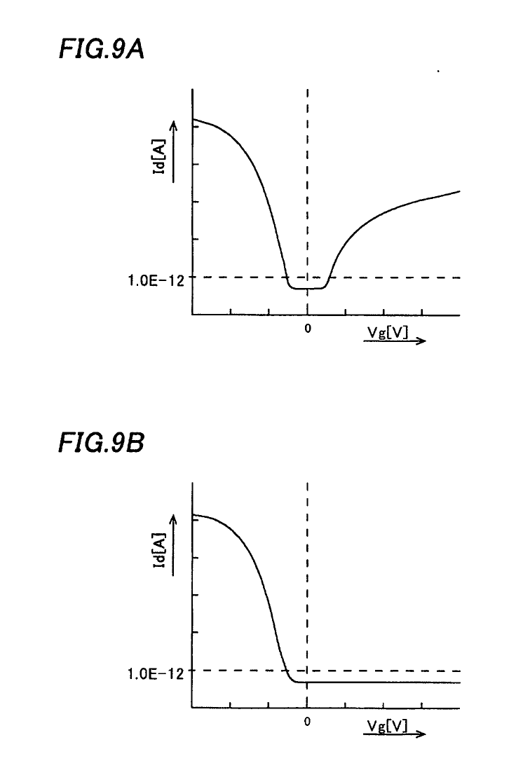

FIGS. 9A and 9B show correlations between a drain current Id and the electric potential Vg at the gate of the driver TFT 214. In FIGS. 9A and 9B, a vertical axis represents the drain current Id while a horizontal axis represents the electric potential Vg at the gate. FIG. 9A shows the correlation before performing the voltage application processing, while FIG. 9B shows the correlation after performing the voltage application processing for a period in the range between approximately 1 μsec and approximately 10 sec.

When the voltage application processing described above is not performed, the drain current Id decreases as the electric potential Vg at the gate of the driver TFT 214 approaches from a negative electric potential to 0V, and the drain current Id increase with a rate of change when the gate electric potential Vg goes beyond 0V, making the leakage current, as shown in FIG. 9A.

When the voltage application processing described above is performed, on the other hand, the drain current Id does not show the tendency to increase and remains below 1 pA even when the gate electric potential Vg goes beyond 0V, as shown in FIG. 9B. In this case, the drain current Id is low enough not to drive the organic EL device 216 to emit light as a bright spot on the display panel 100.

Therefore, when the user tried to suppress the residual image by switching the electric potential of the capacitor line 217 to the second capacitor electric potential Vsc2 during the non-light-emitting period of the organic EL device 216 using the organic EL display device on which the voltage application processing has been performed, the bright spot failure due to the leakage current caused as a side effect in suppressing the residual image can be prevented.

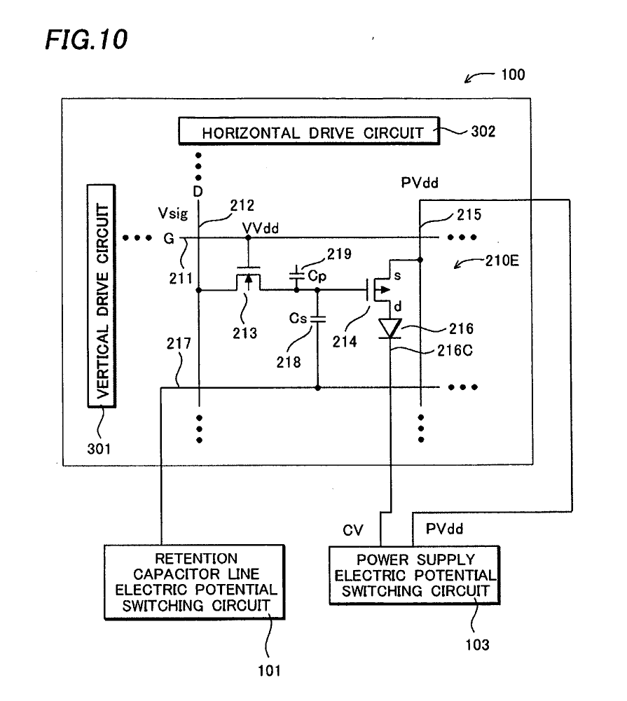

In the above embodiment, the voltage application processing described above is performed on the organic EL display device before it is shipped. However, this invention is not limited to the above. An organic EL display device, that makes a fifth embodiment of this invention, may include outside of its display panel 100 a power supply electric potential switching circuit 103 that reduces an electric potential PVdd on a power supply line 215 in a display pixel 210E and an electric potential CV at a cathode of an organic EL device 216, as shown in FIG. 10.

In this case, each time when a user turns on a power supply of the organic EL display device, predetermined voltages (approximately −5V to the power supply line 215 and approximately −20V to the cathode 216C, for example) to perform the voltage application processing described above are applied from the power supply electric potential switching circuit 103 included in the organic EL display device.

Also, the display signal D and the pixel selection signal G of the predetermined electric potentials to perform the voltage application processing described above are applied using voltages provided from a vertical drive circuit 301 and a horizontal drive circuit 302.

Although a period during which the leakage current can be suppressed by one time of the voltage application processing is limited (1000-1500 hours, for example), the user practically does not need to worry about the limit of the period to suppress the leakage current by performing the voltage application processing each time the user turns on the power supply of the organic EL display device as described above.

Although the organic EL device 216 is used as the light-emitting device in the first through fifth embodiments described above, other light-emitting devices such as an inorganic EL device and a light-emitting diode may be used instead.

Also, although the pixel selection TFT 213 is an N-channel type TFT and the driver TFT 214 is a P-channel type TFT in the first through fifth embodiments described above, these TFTs may be of other channel conductivity types. In the case where the driver TFT 214 is an N-channel type TFT, the second capacitor electric potential Vsc2 is set to be lower than the first capacitor electric potential Vsc1, contrary to the above embodiments. And the second power supply electric potential PVdd2 is set to be higher than the first power supply electric potential PVdd1.

In the active matrix type display device, the quality of display can be improved by suppressing the residual image on the display panel as well as by suppressing the bright spot failure caused as a side effect of suppressing the residual image, according to the embodiments of this invention.

What is claimed is:

1. An active matrix type display device comprising:
a plurality of display pixels arrayed in a matrix form, each of the plurality of display pixels comprising a pixel selection transistor that is turned on according to a pixel selection signal, a light-emitting device, a driver transistor that is connected with a power supply line and drives the light-emitting device according to a display signal applied through the pixel selection transistor and a storage capacitor that is connected between a gate of the driver transistor and a capacitor line and retains the display signal; and
a capacitor line electric potential switching circuit that supplies alternately to the capacitor line a first capacitor electric potential and a second capacitor electric potential that is different from the first capacitor electric potential.

2. The active matrix type display device of claim 1, wherein the second capacitor electric potential is higher than the first capacitor electric potential.

3. The active matrix type display device of claim 2, further comprising a power supply electric potential switching circuit that supplies alternately to the power supply line a first power supply electric potential and a second power supply electric potential that is different from the first power supply electric potential.

4. The active matrix type display device of claim 3, wherein the second power supply electric potential is lower than the first power supply electric potential.

5. An active matrix type display device comprising:
a plurality of display pixels arrayed in a matrix form, each of the plurality of display pixels comprising a pixel selection transistor that is turned on according to a pixel selection signal, a light-emitting device, a driver transistor that is connected with a power supply line and drives the light-emitting device according to a display signal applied through the pixel selection transistor and a storage capacitor that is connected between a gate of the driver transistor and a capacitor line and retains the display signal; and
a power supply electric potential switching circuit that supplies alternately to the power supply line a first power supply electric potential and a second power supply electric potential that is different from the first power supply electric potential.

6. The active matrix type display device of claim 5, wherein the second power supply electric potential is lower than the first power supply electric potential.

7. The active matrix type display device of claim 1, 2, 3, 4, 5 or 6, wherein the light-emitting device comprises an organic electroluminescent device.

8. An active matrix type display device comprising:
a plurality of display pixels arrayed in a matrix form, each of the plurality of display pixels comprising a pixel selection transistor that is turned on according to a pixel selection signal, a light-emitting device that comprises an anode and a cathode, a driver transistor that is connected between a power supply line and the anode and drives the light-emitting device according to a display signal applied through the pixel selection transistor and a storage capacitor that is connected between a gate of the driver transistor and a capacitor line and retains the display signal;
a capacitor line electric potential switching circuit that supplies alternately to the capacitor line a first capacitor electric potential and a second capacitor electric potential that is different from the first capacitor electric potential; and
a power supply electric potential switching circuit that reduces an electric potential of the power supply line and an electric potential at the cathode of the light-emitting device for a predetermined period so that a difference between an electric potential at a gate of the driver transistor and an electric potential at a source of the driver transistor becomes larger in the predetermined period than in a non-light-emitting period of the display device and that a difference between an electric potential at a drain of the driver transistor and the electric potential at the source of the driver transistor becomes larger in the predetermined period than in the non-light-emitting period.

9. The active matrix type display device of claim 8, wherein the predetermined period is between one microsecond and ten seconds.

10. The active matrix type display device of claim 8 or 9, wherein the light-emitting device comprises an organic electroluminescent device.

11. A method of driving an active matrix type display device, comprising:
providing a plurality of display pixels each comprising a pixel selection transistor, a light-emitting device, a driver transistor driving the light-emitting device and connected with a power supply line and a storage capacitor connected between a gate of the driver transistor and a capacitor line;
switching an electric potential of the capacitor line from a first capacitor electric potential to a second capacitor electric potential to turn the driver transistor off;
switching back the electric potential of the capacitor line to the first capacitor electric potential from the second capacitor electric potential; and
applying a display signal to the driver transistor through the pixel selection transistor according to a pixel selection signal after the switching back.

12. The method of claim 11, wherein the second capacitor electric potential is higher than the first capacitor electric potential.

13. The method of claim 12, wherein a period during which the electric potential of the capacitor line is at the second capacitor electric potential is equal to or longer than a 300th of a period during which the electric potential of the capacitor line is at the first capacitor electric potential.

14. The method of claim 13, further comprising switching an electric potential of the power supply line from a first power supply electric potential to a second power supply electric potential that is different from the first power supply electric potential and switching the electric potential of the power supply line back to the first power supply electric potential from the second power supply electric potential.

15. The method of claim 14, wherein the second power supply electric potential is lower than the first power supply electric potential.

16. The method of claim 15, wherein a period during which the electric potential of the power supply line is at the second power supply electric potential is equal to or longer than a 300th of a period during which the electric potential of the power supply line is at the first power supply electric potential.

17. A method of driving an active matrix type display device, comprising:
providing a plurality of display pixels each comprising a pixel selection transistor, a light-emitting device, a driver transistor driving the light-emitting device and connected with a power supply line and a storage capacitor connected between a gate of the driver transistor and a capacitor line;
switching an electric potential of the power supply line from a first power supply electric potential to a second power supply electric potential to turn the driver transistor off;
switching back the electric potential of the power supply line to the first power supply electric potential from the second power supply electric potential; and
applying a display signal to the driver transistor through the pixel selection transistor according to a pixel selection signal after the switching back.

18. The method of claim 17, wherein the second power supply electric potential is lower than the first power supply electric potential.

19. The method of claim 18, wherein a period during which the electric potential of the power supply line is at the second power supply electric potential is equal to or longer than a 300th of a period during which the electric potential of the power supply line is at the first power supply electric potential.

20. The method of claim 11, 12, 13, 14, 15, 16, 17, 18 or 19, wherein the light-emitting device comprises an organic electro luminescent device.

21. A method of driving an active matrix type display device, comprising:
providing a plurality of display pixels each comprising a pixel selection transistor, a light-emitting device comprising an anode and a cathode, a driver transistor driving the light-emitting device and connected between a power supply line and the anode and a storage capacitor connected between a gate of the driver transistor and a capacitor line; and
reducing an electric potential of the power supply line and an electric potential at the cathode of the light-emitting device for a predetermined period so that a difference between an electric potential at a gate of the driver transistor and an electric potential at a source of the driver transistor becomes larger in the predetermined period than in a non-light-emitting period and that a difference between an electric potential at a drain of the driver transistor and the electric potential at the source of the driver transistor becomes larger in the predetermined period than in the non-light-emitting period

22. The method of claim 21, wherein the reducing of the electric potential of the power supply line and the electric potential at the cathode is performed before by a manufacturer of the active matrix type display device.

23. The method of claim 21, wherein the reducing of the electric potential of the power supply line and the electric potential at the cathode is performed when a power supply of the active matrix type display device is turned on.

24. The method of claim 21, 22 or 23, further comprising applying a predetermined display signal to the driver transistor and a predetermined pixel selection signal higher than the predetermined display signal to the pixel selection transistor during the predetermined period.

25. The method of claim 21, 22 or 23, wherein the predetermined period is between one microsecond and ten seconds.

26. The method of claim 21, 22 or 23, wherein the light-emitting device comprises an organic electroluminescent device.

27. The method of claim 24, wherein the predetermined period is between one microsecond and ten seconds.

28. The method of claim 24, wherein the light-emitting device comprises an organic electroluminescent device.

29. The method of claim 27, wherein the light-emitting device comprises an organic electroluminescent device.
